(19) United States
(12) Patent Application Publication
(10) Pub. No.: US 2026/0328900 A1
(43) Pub. Date: Oct. 22, 2026

(54) METHOD AND DETECTION APPARATUS FOR SUPPRESSING CLUTTER USING DELAY-TIME REVERSAL

(71) Applicant: ELECTRONICS AND TELECOMMUNICATIONS RESEARCH INSTITUTE, Daejeon (KR)

(72) Inventors: Sung-Jin YOO, Daejeon (KR); Hyung-Ju KIM, Daejeon (KR); Hyun-Seok KIM, Daejeon (KR); Kyung-Hwan PARK, Daejeon (KR); Byung-Jang JEONG, Seoul (KR); Seok-Bong HYUN, Daejeon (KR); Jung-Hwan HWANG, Daejeon (KR)

(73) Assignee: ELECTRONICS AND TELECOMMUNICATIONS RESEARCH INSTITUTE, Daejeon (KR)

(21) Appl. No.: 19/468,884

(22) Filed: Feb. 3, 2026

(30) Foreign Application Priority Data
Apr. 21, 2025 (KR) 10-2025-0051443

(51) Int. Cl. G01S 7/292; G01S 13/10

(52) U.S. Cl. CPC G01S 7/2921; G01S 13/10

(57) ABSTRACT

Disclosed herein are a method for suppressing clutter using delay-time reversal and a detection apparatus for the same. The detection apparatus may include a transmitter configured to transmit an initial radar signal, a receiver configured to receive an initial radar echo signal generated by the transmitted initial radar signal, a processor configured to extract tentative targets and delay time values of the tentative targets from the received initial radar echo signal and generate delay-time reversal information based on the extracted delay time values of the tentative targets, and a signal generator configured to generate a search radar signal based on the generated delay-time reversal information. The transmitter may transmit the search radar signal, and the receiver may receive a search radar echo signal generated by the search radar signal.

### CROSS REFERENCE TO RELATED APPLICATION

This application claims the benefit of Korean Patent Application No. 10-2025-0051443, filed Apr. 21, 2025, which is hereby incorporated by reference in its entirety into this application.

### BACKGROUND OF THE INVENTION

### 1. Technical Field

The present disclosure relates generally to a method for suppressing clutter using delay-time reversal and a detection apparatus for the same, and more particularly to a method and apparatus for suppressing clutter using delay-time reversal, which enables detection of a target by suppressing clutter that hinders a detection apparatus, such as radar, from extracting the target.

### 2. Description of the Related Art

Clutter refers to signals reflected from objects other than the target that a radar intends to detect. In general, when the amount of clutter is large or the magnitude of the clutter signals is high, the target detection performance of the radar degrades. Therefore, in order to improve detection performance of the radar, it is necessary to reduce clutter that interferes with radar signal processing. Generally, in order to reduce clutter, differences in characteristics between a target and clutter are exploited. For example, when stationary clutter and a moving target are present, a Moving Target Indicator (MTI) technique may be used to detect only the moving target. Alternatively, clutter may first be estimated using the average value of the received signals and then removed from the radar signals so that the target signal becomes more prominent.

In particular, when radar is used in indoor environments, the characteristics of clutter become more complex. In many cases, the target signal is weaker than the clutter, and radar echo signals often arrive via multiple paths, making clutter removal more challenging than in outdoor environments. In order to improve detection performance of the radar in indoor environments, approaches based on time reversal have been studied.

However, implementing such approaches requires sampling and storing a large amount of data and replaying it in reverse at precise timing, which imposes a significant burden on the radar hardware.

### DOCUMENTS OF RELATED ART

(Patent Document 1) KR 10-2019-0032143 A.

### SUMMARY OF THE INVENTION

An object of the present disclosure is to provide a method for suppressing clutter using delay-time reversal and a detection apparatus for the same, which may suppress clutter by employing a delay-time reversal technique.

Another object of the present disclosure is to provide a method for suppressing clutter using delay-time reversal and a detection apparatus for the same, which may be implemented with a simpler hardware configuration and at a lower cost compared to conventional time reversal techniques.

A method for suppressing clutter using delay-time reversal according to the present disclosure may include transmitting an initial radar signal, receiving an initial radar echo signal generated by the transmitted initial radar signal, extracting tentative targets and delay time values of the tentative targets from the received initial radar echo signal, generating delay-time reversal information based on the extracted delay time values of the tentative targets, transmitting a search radar signal based on the generated delay-time reversal information, and receiving a search radar echo signal generated by the transmitted search radar signal.

Transmitting the search radar signal may include transmitting a number of search radar signals equal to the number of extracted tentative targets.

The search radar signals may be transmitted at intervals indicated by the delay-time reversal information.

The delay-time reversal information may include information indicating the delay time values of the tentative targets in reverse order of absolute values of the delay time values of the tentative targets.

The initial radar signal may include at least one of a pulse signal, or a chirp signal, or a combination thereof. When a time interval indicated by the delay-time reversal information is less than the width of the pulse signal, a pulse signal associated with the time interval may be generated by a pulse generator different from a pulse generator that generated a previous pulse signal.

The method for suppressing clutter using delay-time reversal may further include extracting a clutter signal based on the received search radar echo signal and removing clutter from the search radar echo signal using the extracted clutter signal.

The method for suppressing clutter using delay-time reversal may further include detecting a target based on the received search radar echo signal.

The method for suppressing clutter using delay-time reversal may further include extracting an initial delay time value from the received initial radar echo signal.

The method for suppressing clutter using delay-time reversal may further include extracting an effective radar echo signal from the received search radar echo signal based on the extracted initial delay time value.

A detection apparatus for suppressing clutter using delay-time reversal according to the present disclosure may include a transmitter configured to transmit an initial radar signal, a receiver configured to receive an initial radar echo signal generated by the transmitted initial radar signal, a processor configured to extract tentative targets and delay time values of the tentative targets from the received initial radar echo signal and generate delay-time reversal information based on the extracted delay time values of the tentative targets, and a signal generator configured to generate a search radar signal based on the generated delay-time reversal information. The transmitter may transmit the search radar signal, and the receiver may receive a search radar echo signal generated by the search radar signal.

The signal generator may generate a number of search radar signals equal to the number of extracted tentative targets.

The signal generator may generate search radar signals at intervals indicated by the delay-time reversal information.

The delay-time reversal information may include information indicating the delay time values of the tentative targets in reverse order of absolute values of the delay time values of the tentative targets.

The initial radar signal may include at least one of a pulse signal, or a chirp signal, or a combination thereof.

The transmitter may include a plurality of pulse generators configured to generate pulse signals, and when a time interval indicated by the delay-time reversal information is less than the width of the pulse signal, a pulse signal associated with the time interval may be generated by a pulse generator different from a pulse generator that generated a previous pulse signal.

The processor may extract a clutter signal based on the received search radar echo signal and remove clutter from the search radar echo signal using the extracted clutter signal.

The processor may detect a target based on the received search radar echo signal.

The processor may extract an initial delay time value from the received initial radar echo signal.

The processor may extract an effective radar echo signal from the received search radar echo signal based on the extracted initial delay time value.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a view illustrating target detection in an indoor environment using a detection apparatus according to an embodiment of the present disclosure;

FIG. 2 is a block diagram illustrating the configuration of a detection apparatus according to an embodiment of the present disclosure;

FIG. 3 is a view illustrating an operation process of a detection apparatus according to an embodiment of the present disclosure;

FIG. 4 is a block diagram illustrating the configuration of a detection apparatus according to another embodiment of the present disclosure;

FIG. 5 is a graph illustrating an initial radar signal transmitted by the detection apparatus of FIG. 4 and a radar echo signal received by the detection apparatus;

FIG. 6 is a graph illustrating an embodiment in which the detection apparatus of FIG. 4 extracts a tentative target and a delay time;

FIG. 7 is a graph illustrating an embodiment of a radar signal retransmitted by the detection apparatus of FIG. 4;

FIG. 8 is a graph illustrating an embodiment of a general radar signal transmitted by the detection apparatus of FIG. 4;

FIG. 9 is a graph illustrating radar signals retransmitted in FIG. 7 and received radar echo signals;

FIG. 10 is a view illustrating a process of performing a method for suppressing clutter using delay-time reversal according to an embodiment of the present disclosure;

FIG. 11 is a view illustrating a process of performing a method for suppressing clutter using delay-time reversal according to another embodiment of the present disclosure;

FIG. 12 is a graph illustrating another embodiment in which the detection apparatus of FIG. 4 extracts a tentative target and a delay time;

FIG. 13 is a block diagram illustrating the configuration of a detection apparatus according to a further embodiment of the present disclosure;

FIG. 14 is a graph illustrating a radar signal transmitted by the detection apparatus of FIG. 13;

FIG. 15 is a graph illustrating an initial radar signal transmitted by a detection apparatus according to a further embodiment of the present disclosure and a radar echo signal received by the detection apparatus; and

FIG. 16 is a graph illustrating an embodiment of a radar signal retransmitted by a detection apparatus according to a further embodiment of the present disclosure.

### DESCRIPTION OF THE PREFERRED EMBODIMENTS

Because the present disclosure may be variously changed and may have various embodiments, specific embodiments will be described in detail below with reference to the attached drawings. However, it should be understood that those embodiments are not intended to limit the present disclosure to specific disclosure forms and that they include all changes, equivalents or modifications included in the spirit and scope of the present disclosure.

Specific embodiments will be described in detail below with reference to the attached drawings. These embodiments are described in sufficient detail to enable those skilled in the art to practice the embodiments. It should be understood that the embodiments differ from each other, but the embodiments do not need to be exclusive of each other. For example, a particular feature, structure, or characteristic described herein in connection with one embodiment may be implemented in another embodiment without departing from the spirit or scope of the present disclosure. Also, it should be understood that the location or arrangement of individual elements in the disclosed embodiments may be changed without departing from the spirit or scope of the embodiments. Therefore, the following detailed description is not to be taken in a limiting sense, and if appropriately interpreted, the scope of the exemplary embodiments is limited only by the appended claims, along with the full range of equivalents to which the claims are entitled.

In the drawings, similar reference numerals are used to designate the same or similar functions in various aspects. The shapes, sizes, etc. of components in the drawings may be exaggerated to make the description clearer. Also, the terms “and/or” may include combinations of a plurality of related described items or any of a plurality of related described items. The terms “part,” “unit,” and “module” as used herein may include one or more components, and may include software components and/or hardware components.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure. Similarly, a second element could also be referred to as a first element.

It will be understood that when a component is referred to as being “connected” or “coupled” to another component, the two components may be directly connected or coupled to each other, or intervening components may be present between the two components. It will be understood that when a component is referred to as being “directly connected or coupled” to another component, no intervening components are present between the two components.

Components in embodiments are independently illustrated in order to indicate different characteristic functions, but this does not mean that each of the components is formed of a separate piece of hardware or software. That is, components are arranged and included for convenience of description, and at least two of the components may form one component, or one component may be divided into multiple components to perform respective functions. An embodiment into which the components are integrated or an embodiment from which some components are separated is included in the scope of the present disclosure, as long as it does not depart from the essence of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added. That is, in the embodiments, an expression describing that a component “comprises” a specific component means that additional components may be included within the scope of the practice of the present disclosure or the technical spirit of the present disclosure, but does not preclude the presence of components other than the specific component.

In the embodiments, the term “at least one” may mean one of one or more numbers, such as 1, 2, 3, and 4. In the embodiments, the term “a plurality of” may mean one of two or more numbers, such as 2, 3 and 4.

At least portion of the parts, units, and modules described in the embodiments may be program modules and may communicate with external devices or systems.

The program modules may include a routine, a subroutine, a program, an object, a program component, a data structure, and the like for performing functions or operations according to an embodiment or for implementing abstract data types according to an embodiment, but they are not limited thereto.

Some components of embodiments are not essential components for performing essential functions, but may be optional components for improving only performance. The embodiments may be implemented by including only essential components for implementing the essence of the embodiments, excluding components used only to improve performance. For example, a structure including only essential components, excluding optional components used only to improve performance, is also included in the scope of the embodiments.

Hereinafter, embodiments will be described in detail below with reference to the accompanying drawings so that those having ordinary knowledge in the technical field can easily practice the embodiments. In the following description of the embodiments, detailed descriptions of known functions or configurations which are deemed to obscure the gist of the present specification will be omitted. Further, the same reference numerals are used to designate the same components throughout the drawings, and repeated descriptions of the same components will be omitted.

FIG. 1 is a view illustrating target detection in an indoor environment using a detection apparatus according to an embodiment of the present disclosure. FIG. 1 illustrates examples of a radar signal and a radar echo signal in an indoor environment.

Referring to FIG. 1, in an indoor environment, because structures 41 such as walls are present, radar echo signals corresponding to radar signals transmitted by the detection apparatus 10 according to the present disclosure may be received as input via multiple paths. Such radar echo signals interfere with accurate detection of a true target position and sometimes lead to detection of ghost targets, resulting in detection of targets that do not actually exist. Also, in an indoor environment, various types of clutter 31, such as furniture, are present, which may make it difficult to detect a target 20. Similar to the target 20, the various types of clutter 31 are also affected by multiple paths, so it may be difficult to remove the clutter 31. Here, the radar signal may include a pulse signal or a chirp signal.

In an indoor environment, the target 20 to be detected is often a moving object, such as a person or an animal. In order to detect a moving target 20, an MTI filter scheme is commonly used, as described above. However, when many multipath components are present and when the positions and shapes of the clutter 31 are diverse, as in an indoor environment, it is difficult to detect the target 20 using this scheme. The detection apparatus 10 according to the present disclosure may employ a delay-time reversal method in order to accurately detect an object in a multi-path environment.

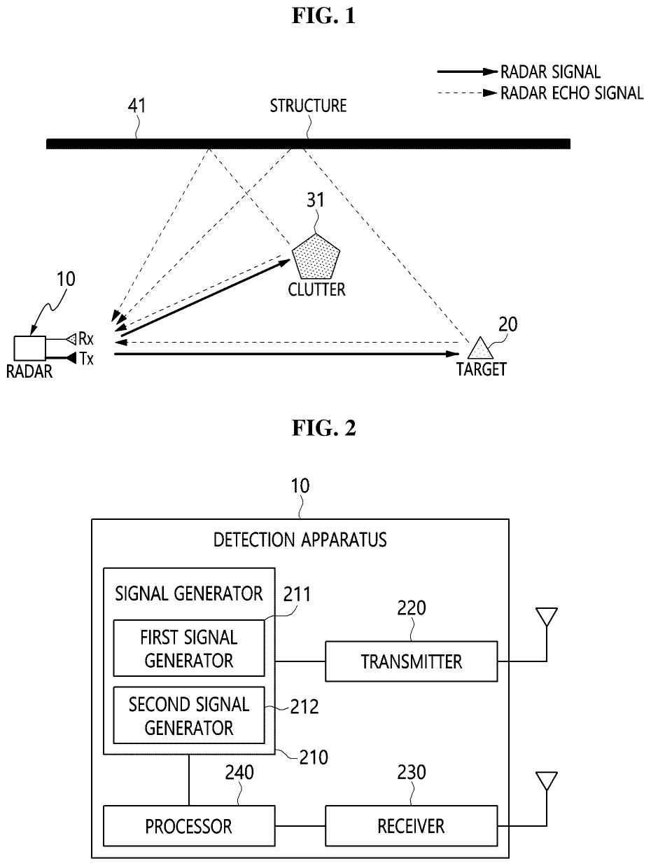

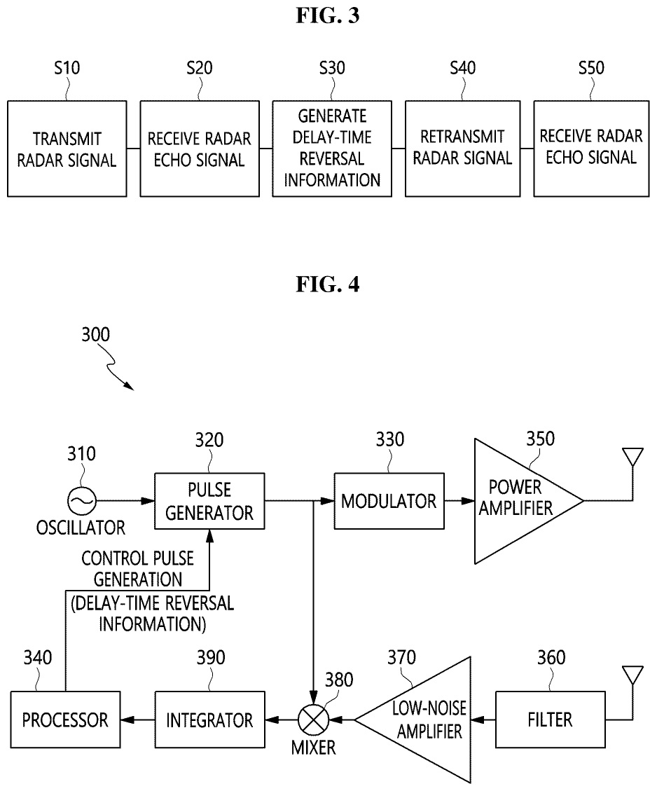

FIG. 2 is a block diagram illustrating the configuration of a detection apparatus according to an embodiment of the present disclosure.

Referring to FIG. 2, the detection apparatus 10 according to the present disclosure may include a signal generator 210, a transmitter 220, a receiver 230, and a processor 240. The detection apparatus 10 according to the present disclosure may include a pulse radar or a Frequency-Modulated Continuous Wave (FMCW) radar.

The signal generator 210 may generate radar signals. The signal generator 210 may generate radar signals based on delay-time reversal information output from the processor 240. The signal generator 210 may generate a radar signal group including a plurality of radar signals based on the delay-time reversal information output from the processor 240 and adjust an interval between radar signals within the radar signal group. Here, the number of radar signals included in the radar signal group may be set depending on the number of tentative targets.

The signal generator 210 may include a first signal generator 211 and a second signal generator 212. The first signal generator 211 and the second signal generator 212 may generate a first radar signal and a second radar signal, respectively. In some embodiments, the signal generator 210 according to the present disclosure may include three or more signal generators, and the three or more signal generators may generate respective radar signals.

The transmitter 220 may modulate a radar signal generated by the signal generator 210 into a signal at a desired frequency and transmit the modulated radar signal. In some embodiments, the transmitter 220 may amplify the modulated radar signal before transmission. The radar signal transmitted by the transmitter 210 may be reflected from respective objects to generate radar echo signals.

The receiver 230 may receive radar echo signals. The receiver 230 may filter the received radar echo signals, perform low-noise amplification on the filtered radar echo signals, mix the amplified radar echo signals with a pulse signal output from the signal generator 210, integrate the mixed radar echo signals, and output the integrated signals to the processor 240.

The processor 240 may detect tentative targets by receiving radar echo signals output from the receiver 230, extract the delay time values of the tentative targets, and generate delay-time reversal information based on the extracted delay time value of the tentative targets. The processor 240 may output the generated delay-time reversal information to the signal generator 210. Here, the delay-time reversal information may include the delay time values of the tentative targets in reverse order of the absolute values of the delay time values. The delay-time reversal information may include information indicating the delay time values of the tentative targets in reverse order of the absolute values of the delay time values of the tentative targets.

Because it only needs to obtain the delay time values of tentative targets from a received signal, the detection apparatus 10 according to the present disclosure may be configured using a relatively low-cost ADC.

FIG. 3 is a view illustrating an operation process of a detection apparatus according to an embodiment of the present disclosure.

Referring to FIG. 3, the detection apparatus 10 according to the present disclosure may perform two phases when it uses a delay-time reversal method.

In the first phase (S10 and S20), the detection apparatus 10 transmits a general radar signal and receives a radar echo signal generated by the transmitted initial radar signal. The radar echo signal in the first phase contains information about positions of objects and multipath propagation. Hereinafter, the radar signal transmitted in the first phase (S10 and S20) and the radar echo signal received in the first phase (S10 and S20) are referred to as an initial radar signal and an initial radar echo signal, respectively.

In the second phase (S30, S40, and S50), the detection apparatus 10 generates delay-time reversal information based on the received radar echo signal, retransmits a radar signal according to the generated delay-time reversal information, receives a radar echo signal generated by the retransmitted radar signal. The retransmitted radar signal may cause time delays resulting from multipath propagation for each tentative target to coincide. Accordingly, in the radar echo signals received in the second phase (S30, S40, and S50), signals reflected from the respective tentative targets may be received with increased strength, whereby more accurate information may be acquired. Hereinafter, the radar signal retransmitted in the second phase (S30, S40, and S50) and the radar echo signal received in the second phase (S30, S40, and S50) are referred to as a search radar signal and a search radar echo signal, respectively. Here, the search radar signal may be transmitted once or two or more times.

FIG. 4 is a block diagram illustrating the configuration of a detection apparatus according to another embodiment of the present disclosure.

Referring to FIG. 4, the detection apparatus 300 according to the present disclosure may include an oscillator 310, a pulse generator 320, a modulator 330, a processor 340, a power amplifier 350, a filter 360, a low-noise amplifier 370, a mixer 380, and an integrator 390.

The detection apparatus 300 is an embodiment in which the detection apparatus 10 is configured as a pulse radar type. That is, the signal generator 210 illustrated in FIG. 2 may include the oscillator 310 and the pulse generator 320, the transmitter 220 illustrated in FIG. 2 may include the modulator 330 and the power amplifier 350, and the receiver 230 illustrated in FIG. 2 may include the filter 360, the low-noise amplifier 370, the mixer 380, and the integrator 390. The processor 240 illustrated in FIG. 2 may include the processor 340 illustrated in FIG. 4.

The oscillator 310 may generate oscillator signals.

The pulse generator 320 may generate pulse signals using the oscillator signals generated by the oscillator 310. The pulse generator 320 may generate pulse signals based on delay-time reversal information output from the processor 340. The pulse generator 320 may generate a pulse group including a plurality of pulses based on the delay-time reversal information output from the processor 340 and adjust an interval between the pulse signals within the pulse group.

The modulator 330 may modulate the pulse signals generated by the oscillator 310 into signals at a desired frequency according to need.

The power amplifier 350 may amplify the pulse signals generated by the pulse generator 320 or the pulse signals modulated by the modulator 330 and transmit the amplified pulse signals. The pulse signals generated by the power amplifier 350 may be reflected from each object to generate radar echo signals.

The filter 360 may filter the radar echo signals and receive the same. The filter 360 may filter the radar echo signals from the signals received from a reception antenna and output the filtered radar echo signals. That is, the filter 360 may remove signals in bands other than a radar echo signal band from the signals received from the reception antenna.

The low-noise amplifier 370 may perform low-noise amplification on the radar echo signals filtered by the filter 360.

The mixer 380 may mix the radar echo signals amplified by the low-noise amplifier 370 with the pulse signal output by the pulse generator 320 and output the mixed signal.

The integrator 390 may integrate the signals output by the mixer and output the integrated signals to the processor 340.

The processor 340 may detect tentative targets by receiving the signals output from the integrator 390, extract delay time values of the tentative targets, and generate delay-time reversal information based on the extracted delay time values of the tentative targets. The detection apparatus 300 according to the present disclosure only needs to obtain the delay time values of the tentative targets from the received signals, so it may be configured using a relatively low-cost ADC.

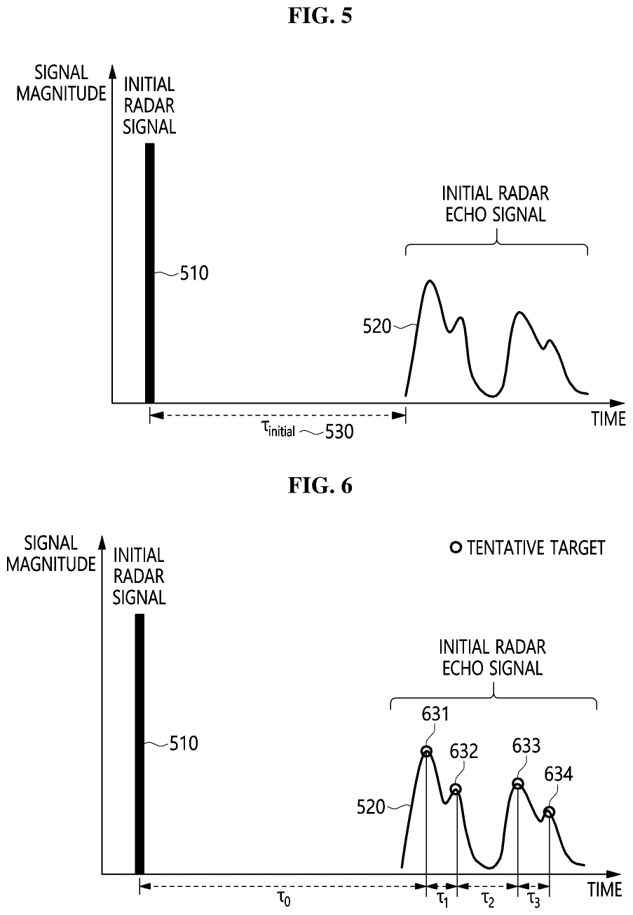

FIG. 5 is a graph illustrating an initial radar signal transmitted by the detection apparatus of FIG. 4 and a radar echo signal received by the detection apparatus.

Referring to FIG. 5, the radar signal 510 and the radar echo signal 520 represent examples of the initial radar signal transmitted at the radar signal transmission step S10 and the initial radar echo signal received at the radar echo signal reception step S20, respectively. The initial radar signal 510 and the initial radar echo signal 520 illustrated in FIG. 5 may have the same form as a general pulse radar transmission signal and reception signal. In order to apply the method proposed in the present disclosure, it is necessary to determine an effective radar echo signal. The detection apparatus 10 according to the present disclosure may ignore radar echo signals that arrive within a specific delay time, that is, an initial delay time value Tinitial 530, extract delay time values using radar echo signals that arrive after the initial delay time value Tinitial 530, and store the initial delay time value Tinitial 530. The initial delay time value Tinitial 530 may be extracted and stored in the first phase (S10 and S20).

At step S10, during transmission of the initial radar signal 510, the transmitter 220 may transmit one pulse signal 510 in each Pulse Repetition Interval (PRI), as in a general pulse radar.

FIG. 6 is a graph illustrating an embodiment in which the detection apparatus of FIG. 4 extracts a tentative target and a delay time.

Referring to FIG. 6, at step S20, the receiver 230 may receive initial radar echo signals 520 generated using a single pulse signal 510.

At step S30, the processor 240 may identify tentative targets 631, 632, 633, and 634 based on the initial radar echo signals 520. Extraction of the tentative targets 631, 632, 633, and 634 is a process of extracting relatively strong signals from signals generated by direct echoes from an object (signals received after radar waves are reflected directly from the object) and multipath echoes from the object (signals received through multipath propagation after radar waves are reflected from the object). Various algorithms, such as Constant False Alarm Rate (CFAR), etc., may be utilized for extracting the tentative targets. That is, the processor 240 may detect the tentative targets 631, 632, 633, and 634 based on the initial radar echo signals 520 by using various CFAR algorithms.

The processor 240 may extract delay time values corresponding to the respective tentative targets 631, 632, 633, and 634 and generate delay-time reversal information based on the extracted delay time values of the respective tentative targets 631, 632, 633, and 634. The processor 240 may store delay time information indicating the delay time values of the tentative targets after extraction of the tentative targets. Here, the delay time information may indicate the absolute values of the delay times corresponding to the respective tentative targets based on the transmitted radar signal or may indicate time interval information between the respective tentative targets. In FIG. 6, the delay times are represented using information on intervals between the tentative targets. Here, To indicates time information between the transmitted signal and the first tentative target, and τ₁, τ₂, and τ₃ represent time intervals between the respective tentative targets. The processor 240 may generate delay-time reversal information based on the extracted delay time information of each of the tentative targets 631, 632, 633, and 634. Here, the delay-time reversal information may include the delay time information of the tentative targets arranged in reverse order of the absolute values of the delay times of the tentative targets.

The processor 240 may output the generated delay-time reversal information to the signal generator 210.

At step S40, the signal generator 210 may generate a search radar signal based on the generated delay-time reversal information, and the transmitter 220 may transmit the search radar signal. Specifically, at step S40, the pulse generator 320 may generate pulse signals at corresponding times based on the delay-time reversal information generated by the processor 340, the modulator 330 modulates the pulse signals generated by the pulse generator 320, and the power amplifier 350 may amplify and transmit the pulse signals modulated by the modulator 330. The detection apparatus 300 according to the present disclosure differs from conventional time reversal methods in that, instead of transmitting a signal obtained by reversing an entire received radar signal, it reverses only pulse transmission timings based on delay-time reversal information and transmits radar signals at the reversed pulse transmission timings.

FIG. 7 is a graph illustrating an embodiment of a radar signal retransmitted by the detection apparatus of FIG. 4.

Referring to FIG. 7, the radar signals 710, 720, 730, 740, 710-2, 720-2, 730-2, and 740-2 are the radar signals retransmitted at step S40 and show an embodiment of search radar signals. Here, the radar signals 710, 720, 730, and 740 may constitute a first radar signal group, and the radar signals 710-2, 720-2, 730-2, and 740-2 may constitute a second radar signal group.

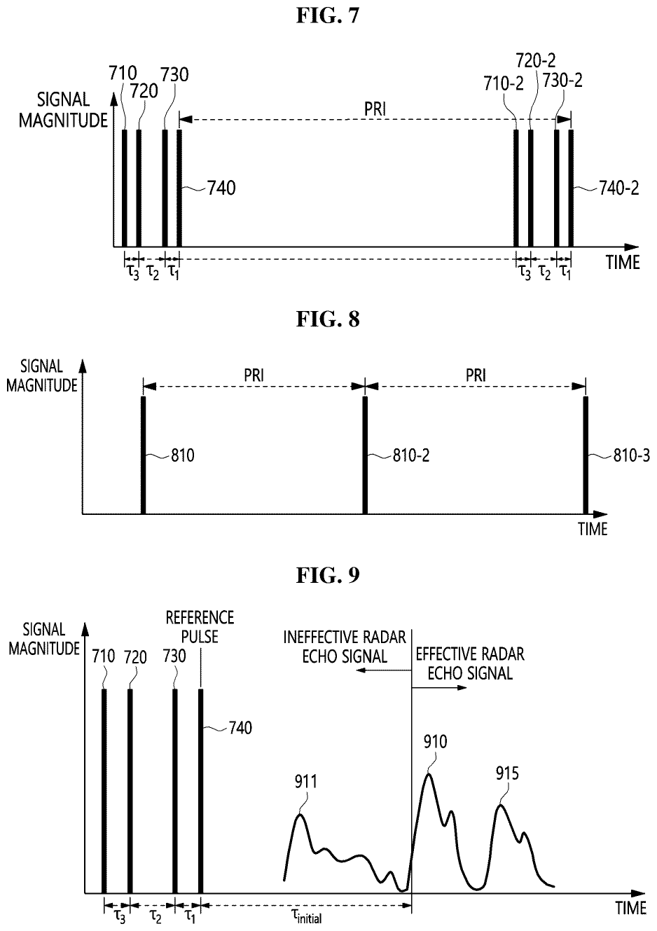

FIG. 8 is a graph illustrating an embodiment of a general radar signal transmitted by the detection apparatus of FIG. 4.

Referring to FIG. 8, when no tentative targets are detected in FIG. 6, the detection apparatus 300 may transmit general radar signals 810, 810-2, and 810-3 using pulse signals, as shown in FIG. 8. Each of the radar signals 810, 810-2, and 810-3 may be transmitted for each PRI.

When tentative targets are present, the detection apparatus 300 may transmit a number of pulses equal to the number of tentative targets. Here, the detection apparatus 300 may set the intervals between pulse signals to τ₃, τ₂, and τ₁ as illustrated in FIG. 7 by reversing the time intervals τ₁, τ₂, and τ₃ between the tentative targets 631, 632, 633, and 634 illustrated in FIG. 6 and may then transmit search radar signals. That is, the detection apparatus 300 may transmit the pulse signal 720 after τ₃ from the time at which the pulse signal 710 is transmitted, transmit the pulse signal 730 after τ₂ from the time at which the pulse signal 720 is transmitted, and transmit the pulse signal 740 after τ₁ from the time at which the pulse signal 730 is transmitted.

The detection apparatus 300 may set the PRI based on the last pulse signal 740 or 740-2 in each radar signal group, as shown in FIG. 9, and may process received signals based on the last pulse signal in each radar signal group. For example, in the first radar signal group including the pulse signals 710, 720, 730, and 740, the pulse signal 740 serves as a reference for the PRI, and in the second radar signal group including the pulse signals 710-2, 720-2, 730-2, and 740-2, the pulse signal 740-2 may be transmitted after one PRI from the time at which the pulse signal 740 is transmitted.

FIG. 9 is a graph illustrating radar signals retransmitted in FIG. 7 and received radar echo signals.

Referring to FIG. 9, the radar echo signal 910 is an embodiment of search radar echo signals that are received when search radar signals 710, 720, 730, and 740 are transmitted. In FIG. 7, the last pulse 740 in each pulse group may be set as a reference radar signal (reference pulse). Among the search radar echo signals 910, signals received within τᵢₙᵢₜᵢₐₗ of FIG. 5 from the time at which the reference radar signal 740 was transmitted may be regarded as ineffective radar echo signals 911, and signals received after τᵢₙᵢₜᵢₐₗ has elapsed from the time at which the reference radar signal 740 was transmitted may be regarded as effective radar echo signals 915. The detection apparatus 10 may use the effective radar echo signals 915 for detection of clutter or a target.

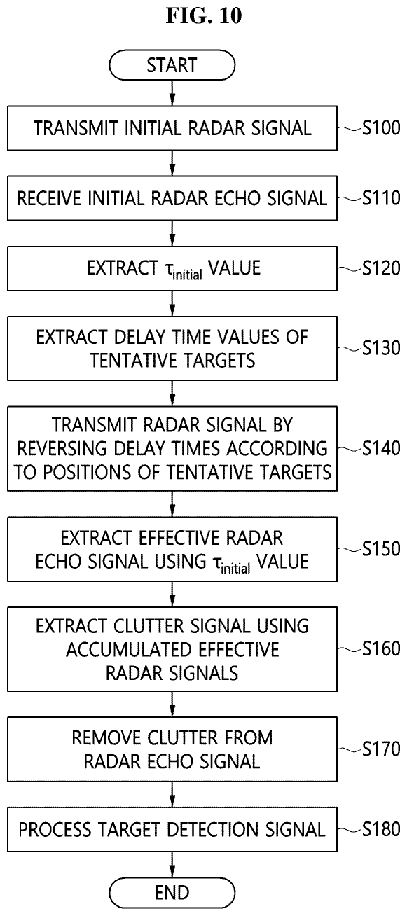

FIG. 10 is a view illustrating a process of performing a method for suppressing clutter using delay-time reversal according to an embodiment of the present disclosure.

Referring to FIG. 10, the detection apparatus 10 transmits an initial radar signal at step S100.

The detection apparatus 10 receives an initial radar echo signal at step S110.

At step S120, the detection apparatus 10 extracts the value of τᵢₙᵢₜᵢₐₗ from the initial radar echo signal received at step S110.

The detection apparatus 10 extracts tentative targets from the initial radar echo signal received at step S110 and extracts a delay time value corresponding to each of the tentative targets at step S130. At step S130, the detection apparatus 10 may store delay time information indicating the delay time values of the tentative targets. Also, the detection apparatus 10 may generate delay-time reversal information based on the delay time information of the tentative targets.

The detection apparatus 10 generates search radar signals and transmits the generated search radar signals at step S140 based on the delay-time reversal information generated at step S130.

The detection apparatus 10 receives search radar echo signals and extracts effective radar echo signals from the received search radar echo signals at step S150 using the value of τᵢₙᵢₜᵢₐₗ extracted at step S120.

The detection apparatus 10 extracts a clutter signal based on the effective radar echo signals at step S160. The detection apparatus 10 may extract fixed clutter information by repeating steps S140 to S160 one or more times. Here, the fixed clutter information may indicate fixed clutter among the tentative targets. The detection apparatus 10 may extract fixed clutter signals using accumulated effective radar echo signals. When the radar signal groups proposed in the present disclosure are transmitted, the magnitude of a signal from a fixed object increases, whereas the magnitude of a signal from a moving object decreases. Therefore, when clutter is fixed and a target is moving, this method may be used. For example, when the first radar signal group (710, 720, 730, and 740) is transmitted, as shown in FIG. 9, the magnitudes of signals from fixed objects, among the tentative targets 631, 632, 633, and 634, increase in the effective radar echo signals 915, but the magnitude of a signal from a moving object decreases. Accordingly, the detection apparatus 10 may detect fixed cluster by identifying tentative targets having increased signal magnitude in the effective radar echo signals 915 and may extract fixed clutter information indicating the detected fixed clutter based on the effective radar echo signals 915.

The detection apparatus 10 removes clutter signals from the effective radar echo signals using the extracted fixed clutter information at step S170.

The detection apparatus 10 detects a target from the effective radar echo signals from which the clutter signal is removed at step S170 and performs signal processing for target analysis at step S180.

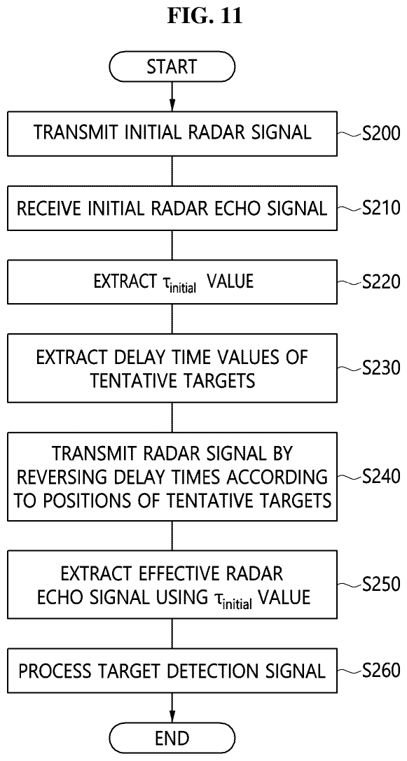

FIG. 11 is a view illustrating a process of performing a method for suppressing clutter using delay-time reversal according to another embodiment of the present disclosure.

Referring to FIG. 11, the detection apparatus 10 transmits an initial radar signal at step S200.

The detection apparatus 10 receives an initial radar echo signal at step S210.

At step S220, the detection apparatus 10 extracts the value of τᵢₙᵢₜᵢₐₗ from the initial radar echo signal received at step S210.

The detection apparatus 10 extracts tentative targets from the initial radar echo signal received at step S210 and extracts a delay time value corresponding to each of the tentative targets at step S230. At step S230, the detection apparatus 10 may store delay time information indicating the delay time values of the tentative targets. Also, the detection apparatus 10 may generate delay-time reversal information based on the delay time information of the tentative targets.

The detection apparatus 10 generates search radar signals and transmits the generated search radar signals at step S240 based on the delay-time reversal information generated at step S230.

The detection apparatus 10 receives search radar echo signals and extracts effective radar echo signals from the received search radar echo signals at step S250 using the value of τᵢₙᵢₜᵢₐₗ extracted at step S220.

The detection apparatus 10 detects a target from the effective radar echo signals extracted at step S250 and performs signal processing for target analysis at step S260. When clutter is moving and a target is fixed, the detection apparatus 10 may directly detect the target without a separate clutter estimation process, as shown in FIG. 11. When the method proposed in the present disclosure is used, the magnitude of a signal from a fixed target becomes relatively larger than that of a signal from moving clutter due to the pulse signals transmitted according to the reversed delay times. Accordingly, the detection apparatus 10 may detect a tentative target having increased signal magnitude as the target, without a separate clutter estimation process.

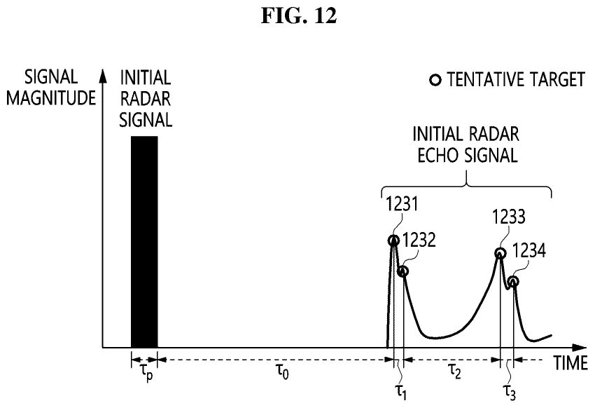

FIG. 12 is a graph illustrating another embodiment in which the detection apparatus of FIG. 4 extracts a tentative target and a delay time. FIG. 12 illustrates an embodiment when an interval between tentative targets is less than a pulse width.

Referring to FIG. 12, a pulse width Tp is generally shorter than time intervals between tentative targets, as illustrated in FIG. 6. However, when the frequency bandwidth of a pulse is small or when pulse compression is applied, the bandwidth of the pulse may be greater than the time intervals between the tentative targets. In this case, it is difficult to apply the delay-time reversal technique using only a single pulse generator 320, as shown in FIG. 4, because the pulse generator 320 generally transmits identical signals at specific timings. In this case, two or more pulse generators may be used for configuration of a delay-time reversal pulse radar.

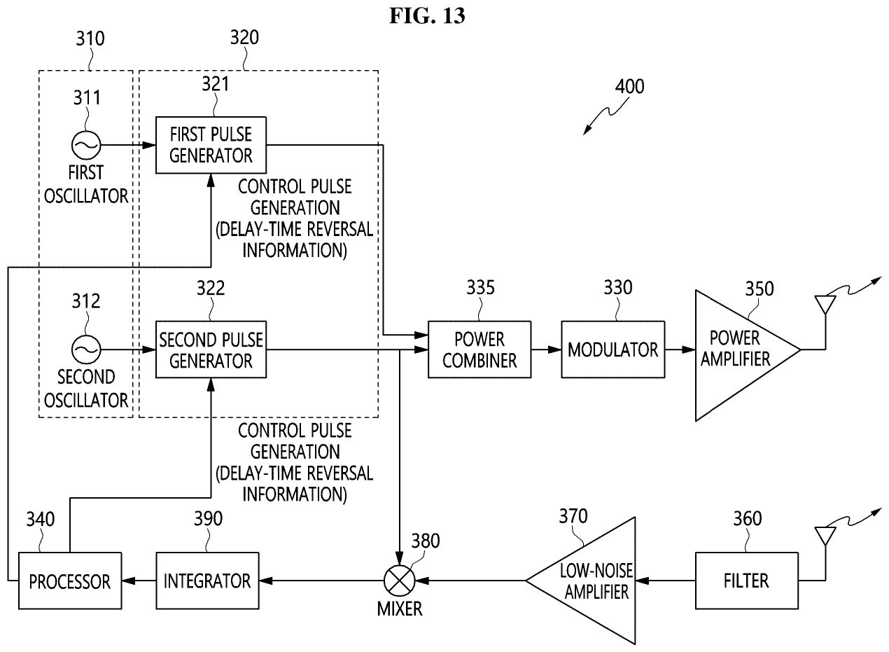

FIG. 13 is a block diagram illustrating the configuration of a detection apparatus according to a further embodiment of the present disclosure. FIG. 13 illustrates an embodiment of a delay-time reversal pulse radar using two pulse generators.

Referring to FIG. 13, the detection apparatus 400 according to the present disclosure may include a first oscillator 311, a first pulse generator 321, a second oscillator 312, a second pulse generator 322, a power combiner 335, a modulator 330, a processor 340, a power amplifier 350, a filter 360, a low-noise amplifier 370, a mixer 380, and an integrator 390.

The detection apparatus 400 is an embodiment in which the detection apparatus 10 is configured as a pulse radar type. That is, the first signal generator 211 illustrated in FIG. 2 may include the first oscillator 311 and the first pulse generator 321, the second signal generator 212 illustrated in FIG. 2 may include the second oscillator 312 and the second pulse generator 322, the transmitter 220 illustrated in FIG. 2 may include the modulator 330, the power amplifier 350, and the power combiner 335, and the receiver 230 illustrated in FIG. 2 may include the filter 360, the low-noise amplifier 370, the mixer 380, and the integrator 390. The processor 240 illustrated in FIG. 2 may include the processor 340 illustrated in FIG. 13.

The first pulse generator 321 may generate pulse signals using oscillator signals generated by the first oscillator 311. The first pulse generator 321 may generate pulse signals based on delay-time reversal information output from the processor 340.

The second pulse generator 322 may generate pulse signals using oscillator signals generated by the second oscillator 312. The second pulse generator 322 may generate pulse signals based on the delay-time reversal information output from the processor 340.

The power combiner 335 may combine the output of the first pulse generator 321 and the output of the second pulse generator 322 and output the combined signal to the modulator 330.

The modulator 330, the processor 340, the power amplifier 350, the filter 360, the low-noise amplifier 370, the mixer 380, and the integrator 390 are components respectively corresponding to the modulator 330, the processor 340, the power amplifier 350, the filter 360, the low-noise amplifier 370, the mixer 380, and the integrator 390 illustrated in FIG. 4, and a description thereof will be omitted below.

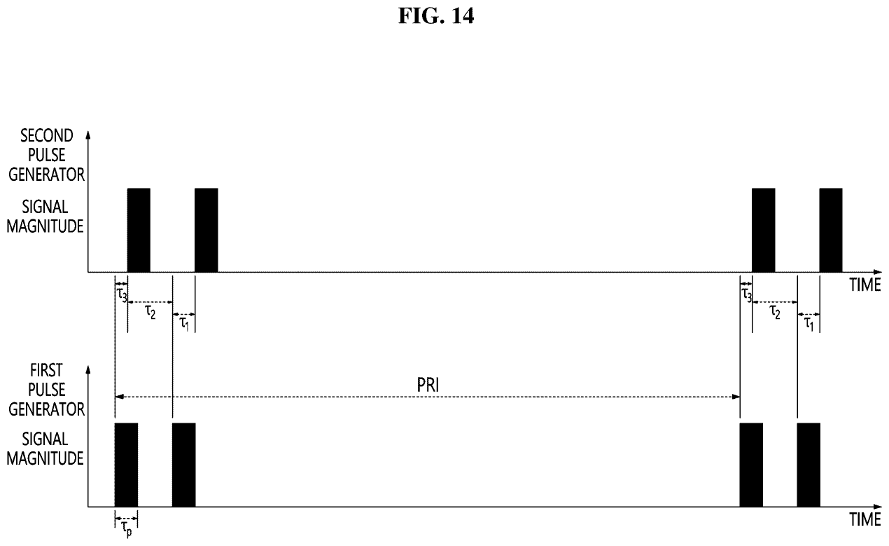

FIG. 14 is a graph illustrating radar signals transmitted by the detection apparatus of FIG. 13. FIG. 14 illustrates pulse transmission timings of the first and second pulse generators illustrated in FIG. 13.

Referring to FIG. 14, the time intervals τ₁ and τ₃ between tentative targets are less than τₚ, and the time interval τ₂ between tentative targets is greater than τₚ. In this case, because it is difficult to generate pulse signals having the intervals τ₁ and τ₃ by using a single pulse generator, the two pulse generators 321 and 322 in FIG. 13 are used to separate pulse signals having the intervals τ₁ and τ₃, and the pulse signals may be respectively transmitted, as shown in FIG. 14. The pulse signals transmitted from the first pulse generator 321 and the second pulse generator 322 may be transmitted as a combined signal by using the power combiner 335.

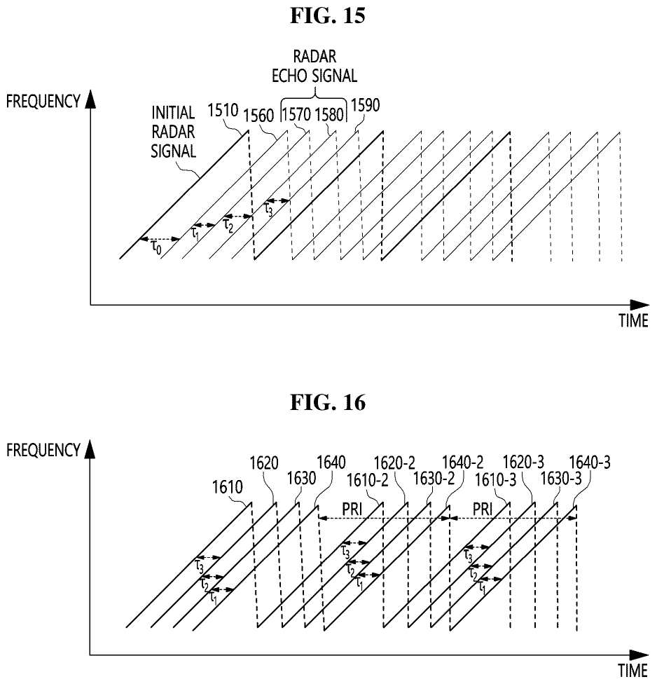

FIG. 15 is a graph illustrating an initial radar signal transmitted by a detection apparatus according to a further embodiment of the present disclosure and a radar echo signal received by the detection apparatus.

Referring to FIG. 15, the detection apparatus 10 may be implemented not only in the pulse radar described above with reference to FIGS. 4 and 13 but also in a Frequency-Modulated Continuous Wave (FMCW) radar. The radar signal 1510 is an embodiment of an initial radar signal transmitted by the detection apparatus 10 implemented as an FMCW radar at step S10, and the radar echo signals 1560, 1570, 1580, and 1590 are embodiments of initial radar echo signals received at step S20.

FIG. 16 is a graph illustrating an embodiment of radar signals retransmitted by a detection apparatus according to a further embodiment of the present disclosure.

Referring to FIG. 16, the radar signals 1610, 1620, 1630, 1640, 1610-2, 1620-2, 1630-2, 1640-2, 1610-3, 1620-3, 1630-3, and 1640-3 are radar signals retransmitted at step S40 and are embodiments of search radar signals.

In FIG. 16, the embodiments of the retransmitted signals 1610, 1620, 1630, and 1640 of the FMCW radar may correspond to the retransmitted signals 710, 720, 730, and 740 of the pulse radar, illustrated in FIG. 7. That is, the radar signal group (1610, 1620, 1630, and 1640) may correspond to the first radar signal group (710, 720, 730, and 740) illustrated in FIG. 7, and the radar signal group (1610-2, 1620-2, 1630-2, and 1640-2) may correspond to the second radar signal group (710-2, 720-2, 730-2, and 740-2) illustrated in FIG. 7.

A difference is that, unlike the pulse radar, the FMCW radar represents delay-time reversal using chirp signals. In the case of the pulse radar, because a single pulse generator may generate a plurality of pulse signals, delay-time-reversed transmission signals may be generated using a single pulse generator when τ₁, τ₂, and τ₃ are greater than the pulse width τₚ. However, in the case of the FMCW radar, a number of chirp signal generators equal to the number of tentative targets is required. Even for FMCW radar signals to be retransmitted, the time intervals τ₁, τ₂, and τ₃ between the tentative targets in FIG. 15 may be arranged in reverse order to generate FMCW radar signals to be retransmitted, as shown in FIG. 16.

In the above-described embodiments, it may be construed that, when specified processing is applied to a specified target, specified conditions may be required. Also, it may be construed that, when a description is made such that the specified processing is performed under a specified decision, whether the specified conditions are satisfied may be determined based on a specified coding parameter and that, alternatively, when a description is made such that a specified decision is made based on a specified coding parameter, the specified coding parameter may be replaced with an additional coding parameter. In other words, it may be considered that a coding parameter that influences the specified condition or the specified decision is merely exemplary, and it may be understood that, in addition to the specified coding parameter, a combination of one or more other coding parameters may function as the specified coding parameter.

In the above-described embodiments, although the methods have been described based on flowcharts as a series of steps or units, the present disclosure is not limited to the sequence of the steps and some steps may be performed in a sequence different from that of the described steps or simultaneously with other steps. Further, those skilled in the art will understand that the steps shown in the flowchart are not exclusive and may further include other steps, or that one or more steps in the flowchart may be deleted without departing from the scope of the present disclosure.

The above-described embodiments include various aspects of examples. Although not all possible combinations for indicating various aspects can be described, those skilled in the art will recognize that additional combinations other than the explicitly described combinations are possible. Therefore, it may be appreciated that the present disclosure includes all other replacements, changes, and modifications belonging to the accompanying claims.

The above-described embodiments according to the present disclosure may be implemented as program instructions that can be executed by various computer components and may be recorded on a computer-readable storage medium. The computer-readable storage medium may include program instructions, data files, and data structures, either solely or in combination. Program instructions recorded on the computer-readable storage medium may have been specially designed and configured for the present disclosure, or may be known to or available to those who have ordinary knowledge in the field of computer software.

The computer-readable storage medium may include information used in embodiments according to the present disclosure. For example, the computer-readable storage medium may include a bitstream, which may include information described in the embodiments according to the present disclosure.

The bitstream may include computer-executable code and/or a program. The computer-executable code and/or program may include pieces of information described in the embodiments and syntax elements described in the embodiments. That is, the pieces of information and syntax elements described in the embodiments may be regarded as computer-executable code within the bitstream, and may be regarded as at least part of the computer-executable code and/or program represented as a bitstream.

The computer-readable storage medium may include a non-transitory computer-readable medium.

Examples of the computer-readable storage medium include all types of hardware devices specially configured to record and execute program instructions, such as magnetic media, such as a hard disk, a floppy disk, and magnetic tape, optical media, such as compact disk (CD)-ROM and a digital versatile disk (DVD), magneto-optical media, such as a floptical disk, ROM, RAM, and flash memory. Examples of the program instructions include machine code, such as code created by a compiler, and high-level language code executable by a computer using an interpreter. The hardware devices may be configured to operate as one or more software modules in order to perform the operation of the present disclosure, and vice versa.

The method for suppressing clutter using delay-time reversal and the detection apparatus for the same according to the present disclosure suppress clutter by employing a delay-time reversal technique using a simpler hardware structure compared to a time reversal technique, thereby effectively reducing clutter and enhancing target detection accuracy. Also, because it is not necessary to significantly modify an existing radar configuration, implementation is facilitated, and performance comparable to that of time-reversal radar may be achieved at a relatively low cost.

As described above, although the present disclosure has been described based on specific details such as detailed components and a limited number of embodiments and drawings, the embodiments are merely provided for easy understanding of the entire disclosure, the present disclosure is not limited thereto, and those skilled in the art will practice various changes and modifications from the above description.

Accordingly, the spirit of the present disclosure should not be construed as being limited to the above-described embodiments, and the entire scope of the appended claims and their equivalents should be understood as defining the scope and spirit of the present disclosure.

What is claimed is:

1. A method for suppressing clutter using delay-time reversal, comprising:
transmitting an initial radar signal;
receiving an initial radar echo signal generated by the transmitted initial radar signal;
extracting tentative targets and delay time values of the tentative targets from the received initial radar echo signal;
generating delay-time reversal information based on the extracted delay time values of the tentative targets;
transmitting a search radar signal based on the generated delay-time reversal information; and
receiving a search radar echo signal generated by the transmitted search radar signal.

2. The method of claim 1, wherein transmitting the search radar signal comprises
transmitting a number of search radar signals equal to a number of extracted tentative targets.

3. The method of claim 2, wherein the search radar signals are transmitted at intervals indicated by the delay-time reversal information.

4. The method of claim 1, wherein the delay-time reversal information includes information indicating the delay time values of the tentative targets in reverse order of absolute values of the delay time values of the tentative targets.

5. The method of claim 1, wherein the initial radar signal includes at least one of a pulse signal, or a chirp signal, or a combination thereof.

6. The method of claim 5, wherein, when a time interval indicated by the delay-time reversal information is less than a width of the pulse signal, a pulse signal associated with the time interval is generated by a pulse generator different from a pulse generator that generated a previous pulse signal.

7. The method of claim 1, further comprising:
extracting a clutter signal based on the received search radar echo signal; and
removing clutter from the search radar echo signal using the extracted clutter signal.

8. The method of claim 1, further comprising:
detecting a target based on the received search radar echo signal.

9. The method of claim 1, further comprising:
extracting an initial delay time value from the received initial radar echo signal.

10. The method of claim 9, further comprising:
extracting an effective radar echo signal from the received search radar echo signal based on the extracted initial delay time value.

11. A detection apparatus for suppressing clutter using delay-time reversal, comprising:
a transmitter configured to transmit an initial radar signal;
a receiver configured to receive an initial radar echo signal generated by the transmitted initial radar signal;
a processor configured to extract tentative targets and delay time values of the tentative targets from the received initial radar echo signal and generate delay-time reversal information based on the extracted delay time values of the tentative targets; and
a signal generator configured to generate a search radar signal based on the generated delay-time reversal information,
wherein
the transmitter transmits the search radar signal, and
the receiver receives a search radar echo signal generated by the search radar signal.

12. The detection apparatus of claim 11, wherein the signal generator generates a number of search radar signals equal to a number of extracted tentative targets.

13. The detection apparatus of claim 12, wherein the signal generator generates the search radar signals at intervals indicated by the delay-time reversal information.

14. The detection apparatus of claim 11, wherein the delay-time reversal information includes information indicating the delay time values of the tentative targets in reverse order of absolute values of the delay time values of the tentative targets.

15. The detection apparatus of claim 11, wherein the initial radar signal includes at least one of a pulse signal, or a chirp signal, or a combination thereof.

16. The detection apparatus of claim 15, wherein
the transmitter includes a plurality of pulse generators configured to generate pulse signals, and
when a time interval indicated by the delay-time reversal information is less than a width of the pulse signal, a pulse signal associated with the time interval is generated by a pulse generator different from a pulse generator that generated a previous pulse signal.

17. The detection apparatus of claim 11, wherein the processor extracts a clutter signal based on the received search radar echo signal and removes clutter from the search radar echo signal using the extracted clutter signal.

18. The detection apparatus of claim 11, wherein the processor detects a target based on the received search radar echo signal.

19. The detection apparatus of claim 11, wherein the processor extracts an initial delay time value from the received initial radar echo signal.

20. The detection apparatus of claim 19, wherein the processor extracts an effective radar echo signal from the received search radar echo signal based on the extracted initial delay time value.
